(19) United States
(12) Patent Application Publication
(10) Pub. No.: US 2008/0073869 A1
(43) Pub. Date: Mar. 27, 2008

(54) Human powered vehicle drive system

(76) Inventor: Sam Harwell Patterson, Fort Lauderdale, FL (US)

Correspondence Address: RYNDAK & SURI LLP, 200 W. MADISON STREET, SUITE 2100, CHICAGO, IL, 60606, US

(21) Appl. No.: 11/904,097

(22) Filed: Sep. 26, 2007

Related U.S. Application Data
(60) Provisional application No. 60/847,128, filed on Sep. 26, 2006.
(60) Provisional application No. 60/903,329, filed on Feb. 26, 2007.

(51) Int. Cl. B62M 3/00; B62M 1/14

(52) U.S. Cl. 280/244

(57) ABSTRACT

The present invention provides a human powered vehicle drive system that includes a vehicle frame, a power system including a pivotable drive lever and a one-way clutch, a neutral shifting system, and a braking system. The drive lever may be coupled to a tension member that is associated with the drive lever and a drive spool, so that power is transmitted from the drive lever to the drive spool via the tension member, and from the drive spool to a driven wheel via the one-way clutch. A drive-ratio shifting control allows a user to vary a drive ratio by translating the attachment point of the tension member to the drive lever up or down the drive lever. A neutral shifting control allows the user to engage and disengage the one-way clutch. The braking system includes a flexible brake linkage routed along the drive lever. The drive-ratio shifting, neutral shifting, and braking controls may all be situated proximate to a drive lever handle adjustably coupled to the drive lever. Additionally, the drive lever is biased in the forward direction by power-stroke assisting springs, which store energy applied in recovery strokes applied to the drive levers, then releasing the energy to assist in forward power strokes. An assembly including the power system, neutral shifting system and brake system integrated with each driven wheel may be released from the chair by a quick release mechanism.

### CROSS-REFERENCE TO RELATED APPLICATIONS

This application claims the benefit of U.S. Provisional Applications Nos. 60/847,128, filed Sep. 26, 2006, and 60/903,329, filed Feb. 26, 2007, the disclosures of which are hereby incorporated in their entireties.

### FIELD OF THE INVENTION

The present invention relates generally to the field of human powered vehicles, and more specifically to human-powered wheelchairs. Still more specifically, the present invention relates to a human-powered wheelchair having a quickly releasable assembly including a drive-lever power system, a neutral shifting system, a brake system and a driven wheel.

### BACKGROUND OF THE INVENTION

### Wheelchair Drive Systems

There have long been wheelchairs for mobilizing the injured or disabled under the power of the chair occupant, i.e., human powered wheelchairs. Human powered wheelchairs fall into three major groups. The first group is human powered wheelchairs that are propelled using hand rims which are nearly the diameter of the driven wheels. This arrangement is highly mechanically efficient; however the ergonomics are extremely poor. The power stroke of the hand gripping and pushing the hand rim begins in an awkward position and follows an unnatural forward and downward movement. The downward component of the power stroke is associated with chest compression and forward upper spinal posture. This arrangement also requires the hand to move at a speed essentially equal to the speed of the chair relative to the ground it is covering. The result is that only low speeds are comfortably attainable. The power stroke movement primarily uses small muscles in the front of the shoulder and is associated with repetitive stress injuries to the shoulder.

A version of hand rim propelled wheelchairs has been developed for racing. The diameter of the hand rims is significantly smaller than the wheel diameter. This effectively gives the chair a higher drive ratio for higher speeds. However, the basic ergonomic problems associated with the power stroke remain.

The second group of human powered wheelchairs uses a bicycle style crank adapted for hand power combined with conventional bicycle drive train components. This group of wheelchairs is specialized for speed and is essentially a three or four wheeled bicycle with a pedal crank adapted for hand propulsion. They are not as maneuverable or versatile as wheelchairs in general. For example, they cannot “turn on a dime.”

The third group of human powered wheelchairs is propelled by hand levers. Many varieties of mechanisms have been put forward in the prior art for mechanically connecting drive levers to the wheels for propulsion. An advantage inherent to this group of human powered wheelchairs is that they retain the versatile and maneuverable functionality of a conventional wheelchair while dramatically improving the ergonomics of the power stroke.

In this third group of human powered wheelchairs the conventional hand rims of the first group are generally retained for low speed maneuvering, reversing, and “turning on a dime.”

Many configurations of lever driven wheelchairs have been put forward in the prior art. The drive levers may be pivoted at the wheel axle, but that configuration does not improve the forward and downward power stroke that is associated with chest cavity compression and forward upper spinal posture. The downward component of the power stroke puts unnecessary stress on the shoulder ligaments. The fossa of the shoulder is better suited to support the forward component of a power stroke.

A preferable location for the lever pivot is forward of the wheel axle so that the power stroke substantially avoids the downward component of movement. This allows the user to enjoy a more upright chest and spinal posture. It also aligns the fossa with the ball of the humerus in the direction of force.

Various mechanical means have been employed to connect the movement of such a lever to the driven wheels of the chair. Some mechanisms use rigid components such as chains and sprockets, gears, and cams. One disadvantage of these mechanisms is that there is friction between the driving elements. The friction can be mitigated somewhat by the use of lubricants, but not eliminated entirely. Lubricants are also messy. Another disadvantage of these mechanisms is that separate load paths involving duplication of mechanisms are required to enable a variety of drive ratios. Therefore such a transmission with a larger number of available drive ratios will necessarily be more complicated, heavier, and more expensive than a similar mechanism with fewer available drive ratios. For example, multiple sprockets, or multiple sun gears with different tooth counts and mechanisms for directing the load path among them are required.

In another mechanism pertaining to this third group of lever propelled prior art, the mechanical connection between the drive levers and the driven wheels comprises a flexible tension element. The tension element is connected to the drive lever in such a way that it unwinds from a spool coaxial with the driven wheel. The spool has a ratchet connection to the wheel and the spool is spring loaded in the reverse direction to keep tension in the tension element during the reverse or recovery stroke. When the drive lever is pushed forward, the wheel is rotated in the forward direction. The ratchet engages the spool to the wheel when the spool is rotating forward faster than the wheel. When the spool is reversing or not keeping up with the forward rotation of the wheel, the ratchet disengages.

This configuration alleviates most of the friction associated with sprockets, gears, cams, etc. The reason for the substantial elimination of friction in the drive train is the fact that the tension element simply unwinds from drive spool during the power stroke. There is no sliding or rubbing between the tension element and drive spool.

This configuration also enables the possibility of a large variety of drive ratios with very little additional mechanism or weight. Three ways to change the drive ratios are known. One method is to use an additional pulley to change the path of the drive cable relative to the attachment point on the drive lever. This method employs trigonometric effects and does indeed vary the effective drive ratio. However, the additional pulley must be rigidly supported in a variety of positions. This modulating pulley is in the load path and can only reduce mechanical efficiency. It has been suggested that the variety of modulating pulley positions can be enabled using a gear motor with batteries for power. This is obviously heavy and high maintenance.

Alternatively, the attachment point of the cable to the drive lever can be manually varied. For example, the occupant can manually slide cable attachment brackets among notched locations on the drive lever. This requires that the occupant move his hand from the drive lever handle portion of the lever to the cable attachment bracket to effect a gear change. This is awkward because, for example, the brake lever which is located at the drive lever handle cannot be actuated during a change of drive ratios.

Still another method employs a lead screw cooperating with twistgrips on the drive lever handles to enable more convenient adjustment of the cable attachment point to change drive ratios. However, the use of such a lead screw forces the drive lever handle to be in a fixed position relative to the drive lever. The twistgrip is necessarily a straight line extension of the drive lever. This is not the best posture for the wrist during the power stroke. It is also desirable to vary the wrist position from time to time to avoid repetitive motion injury.

There is also the problem of shifting the transmission into a neutral or disconnected state to enable the occupant to position the drive levers without propelling the chair. For example, on entering or exiting the chair, the occupant may wish the transmission to be disengaged, so that any incidental disturbance of the drive levers would not cause the chair to move. Also, the occupant may wish to be able to drive a wheelchair up to a table or desk and then back up or “turn on a dime” to exit the table or desk. The present inventor knows of no existing wheelchair transmission that is driven by a flexible tension element provides for a neutral state.

Although the flexible tension element drive systems alleviate the friction associated with gears, sprockets and cams, the systems have another source of wasted energy. The rewind spring that is necessary to rewind and keep tension on the tension element releases potential energy to wind up the cable and accumulates potential energy during the power stroke. In other words, the cable rewind spring works against the occupant during the power stroke. An amount of energy equal to the length of the power stroke at the cable attachment multiplied by the cable tension due to the recoil spring is wasted each power stroke.

### Wheelchair Braking Systems

Many wheel braking systems have been put forward in the prior art such as cable actuated disk and drum brakes. These are preferable to rim brakes as are common on bicycles because they tolerate greater axial run out of the wheel rims. They are also generally higher performance than rim brakes and are less affected by water should the chair be driven through puddles and rain. Such brakes have been used in conjunction with quick release wheelchair wheels. However, the brake mechanisms disclosed are integral with the chair and not the removable wheel. This adds to the weight of the chair which is already the heaviest component among the two quickly removable driven wheels and chair. Users generally prefer that any additional weight be added to the wheels as opposed to the chair. Furthermore, in such arrangements, attaching a wheel typically requires awkward maneuvering to align the brake stator and rotor, and subsequent adjustment or calibration of the brake system. If a user forgets to adjust the brake system after reattaching a wheel, a dangerous operating condition may result.

Therefore, there is a need for a wheelchair with an ergonomic drive system; a convenient, lightweight shifting mechanism providing for a neutral state; and an effective braking system that does not add excessive weight to the chair.

### SUMMARY OF THE INVENTION

In a first aspect, the present invention provides a human powered vehicle drive system comprising a drive lever operatively connected to a drive rotor so that the drive rotor is constrained to rotate in a driving direction with respect to a vehicle frame when a power stroke is applied to the drive lever. The drive lever is pivotally mounted relative to the vehicle frame, and the drive rotor is rotatably mounted relative to the vehicle frame. A power-stroke assisting spring provides a power-stroke assisting torque to the drive lever about a drive-lever pivot to bias the drive lever in the power-stroke direction. The vehicle frame may be a wheelchair frame and the drive rotor a drive spool, where a tension element operatively connects the drive lever to the drive spool, unwinding from the drive spool and causing the drive spool to rotate in a driving direction when a power stroke is applied to the drive lever. In this arrangement, a spool rewind spring keeps the tension element taut and rewinds it onto the drive spool during a recovery stroke of the drive lever. Tension in the tension element due to the spool rewind spring causes a biasing torque on the drive lever in the recovery stroke direction, which may be greater than, equal to, or less than the power-stroke assisting torque provided by the power-stroke assisting spring.

In another aspect, the present invention provides a human powered vehicle drive system with a drive-ratio shifting mechanism. The drive system comprises a drive lever pivotally mounted relative to a vehicle frame about a drive-lever pivot, a shift traveler slidingly connected to the drive lever, a tension element connected to the shift traveler and a drive spool, a shift actuator and drive-ratio shift linkage cooperating to displace the shift traveler along the drive lever, and a spool rewind spring biasing the drive spool in a rewind direction, thereby tending to wind the tension element onto the drive spool. The shift actuator transmits movement through the drive-ratio shift linkage to the shift traveler until an engaging feature integral with the shift traveler engages one of a plurality of receiving features integral with the drive lever. In this way, a user is able to select a desired drive ratio of power-stroke rotation of the drive lever to driving rotation of the drive spool. During a recovery stroke of the drive lever and when the drive lever is at rest, tension in the tension element provided by the spool rewind spring is sufficient to retain the engaging feature in engagement with a receiving feature. On the other hand, the range of contact angles between the engaging feature and the surfaces of the receiving features during a power stroke are sufficient to prevent the engaging feature from disengaging the receiving feature due to the component of tension in the tension element tangential to the drive lever. The human powered vehicle drive system with a drive-ratio shifting mechanism may further comprise a power-stroke assisting spring providing a power-stroke assisting torque to the drive lever about the drive-lever pivot. The drive system may also be incorporated in a wheelchair wherein the vehicle frame is a wheelchair frame, the wheelchair having a driven wheel rotatably mounted relative to the wheelchair frame and constrained to rotate forward with respect to the wheelchair frame by a one-way clutch, the one-way clutch, however, allowing the drive spool to rotate in the rewind direction without kinematic restraint from the driven wheel.

In still another aspect, the present invention provides a human powered vehicle drive system with a power system and a neutral shifting system. The power system has a drive lever operatively connected to a drive spool by a tension element, the tension element constrained to unwind from the drive spool when a power stroke is applied to the drive lever, thereby rotating the drive spool in a driving direction. The drive lever is pivotally mounted and the drive spool is rotatably mounted relative to a vehicle frame. A one-way clutch, when engaged, constrains a driven rotatable propulsion member to rotate so as to propel the vehicle frame forward when the drive spool rotates in the driving direction and allows the drive spool to rewind without kinematic restraint from the propulsion member. Disengaging the one-way clutch permits the drive spool and propulsion member to rotate freely relative to each other. The neutral shifting system comprises a neutral shift actuator operatively connected to a neutral shift linkage, the neutral shift linkage operatively connected to the one-way clutch, whereby actuating the neutral shift actuator engages and disengages the one-way clutch. The drive system may further include a power-stroke assisting spring providing a power-stroke assisting torque to the drive lever about a drive lever pivot. Also, the neutral shift actuator may be proximate to a drive-lever handle, the drive-lever handle coupled to the drive lever. The angle of the drive-lever handle with respect to the drive lever may be adjustable according to a user's preference.

In still another aspect, the present invention provides a human powered wheelchair incorporating a power system as described in the previous aspect, wherein the vehicle frame is a wheelchair frame and the propulsion member is a wheel, the wheelchair further comprising a brake system, wherein the power system and brake system are assembled to a driven wheel that is quickly releasable from the wheelchair frame. In this aspect, the brake system comprises a brake actuator proximate to a drive lever handle coupled to the drive lever, where the brake actuator is connected to a flexible brake linkage and the flexible brake linkage is operatively connected to a brake. The wheelchair according to this aspect may further comprise a neutral shifting system, drive-ratio shifting mechanism or power-stroke assisting spring as previously described. Again, the angle of the drive-lever handle with respect to the drive lever may be adjustable according to a user's preference.

In still another aspect, the present invention provides a human powered wheelchair comprising a drive-lever and rotor power system with a one-way clutch and driven wheel as previously described, and further comprising a brake system including a flexible brake linkage routed along the drive lever. The flexible brake linkage is operatively connected to a brake actuator at its proximal end and to a brake at its distal end. Despite the brake linkage being routed along the drive lever, movement of the drive lever will not apply the brake when the brake actuator has not been triggered. The wheelchair according to this aspect may further comprise a power-stroke assisting spring as previously described. The brake actuator may be proximate to a drive-lever handle coupled to the drive lever, and the angle of the drive-lever handle with respect to the drive lever may be adjustable according to a user's preference.

### BRIEF DESCRIPTION OF THE DRAWINGS

The present invention, and the attendant advantages and features thereof, will be more readily understood by reference to the following detailed description when considered in conjunction with the accompanying drawings, wherein like designations refer to like elements, and wherein:

FIG. 1 illustrates the complete wheelchair equipped with the novel drive system.

FIG. 2 illustrates a cross section of the right side driven special hub 50.

FIG. 3 illustrates an inboard view of the drive system with an exploded view of the mounting bracket system.

FIG. 4 illustrates an inboard view of the drive system.

FIG. 5 illustrates a cross section of the right driven hub including a portion of the axle tube to which the right driven hub is attached.

FIG. 6 is an inboard view of the drive system showing the power-stroke assisting springs and cable routing through the drive lever pivot support bracket.

FIG. 7 illustrates the operation of the neutral shift thumb lever.

FIG. 8 reveals portions of the neutral shift cable and the brake cable internally routed along the drive lever and over the neutral shift and brake pulleys.

FIG. 9 illustrates the drive ratio shifting action.

FIG. 10 reveals the drive-ratio shift cable spools inside the drive lever handle.

FIG. 11 illustrates the neutral shift cam ring and pawl plate

FIG. 12 illustrates the pawl plate return spring and shift fork preload spring.

FIG. 13 illustrates the drive spool situated in the hub.

FIG. 14 illustrates the neutral shift fork with the integral slipper ring engaged to the male dog ring.

FIG. 15 is an exploded view of the engaging relationship between the male dog ring and neutral shift female dog ring.

FIG. 16 illustrates the neutral shift fork preload spring seat.

FIG. 17 illustrates the drive spool with the male dog ring and neutral shift fork assembled into the hub.

FIG. 18 illustrates the female dog ring assembled into the hub.

FIG. 19 illustrates the brake lever.

FIG. 20 illustrates the brake cable and brake actuator arm assembled to the hub.

FIG. 21 illustrates the brake shoes, brake actuator cam, and brake drum assembled to the hub

FIGS. 22 and 23 illustrate the engagement of the antirotation latch system

FIGS. 24 and 25 illustrate the functional elements of the adjustable drive lever knuckle.

### DETAILED DESCRIPTION OF THE INVENTION

While the present invention may be used in any vehicle or craft, particularly wherein a reciprocating input motion is converted to a rotating output motion, the example of a wheelchair is used to explain the invention in the following description and illustrated embodiments. In the interest of a clear description, the structure of a wheelchair is first outlined, and then the mechanisms of the lever drive system and associated features are described in detail.

### Structural Elements of Wheelchair

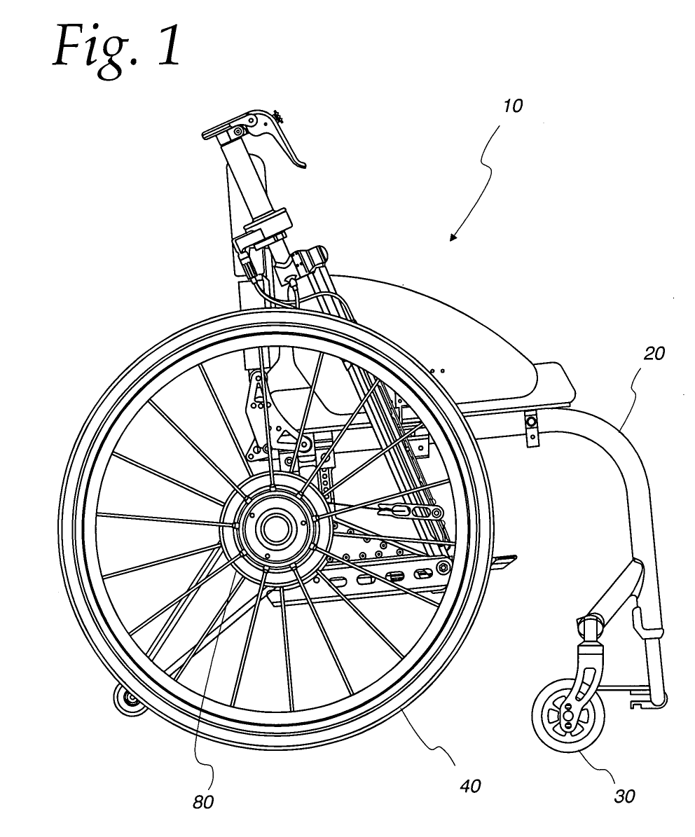

A lever drive wheelchair is generally designated as 10 in FIG. 1. Wheelchair 10 includes a conventional chair frame 20 with all the usual features known in the art. The front of chair 10 is supported on self steering casters 30. There are right and left casters for balance.

The rest of the weight of the chair is supported by the driven wheels 40. These can be provided with conventional hand rims (not shown) for conventional hand power and maneuvering. Again there is a right and a left driven wheel for balance. Wheelchair 10 is preferably a four wheeled chair.

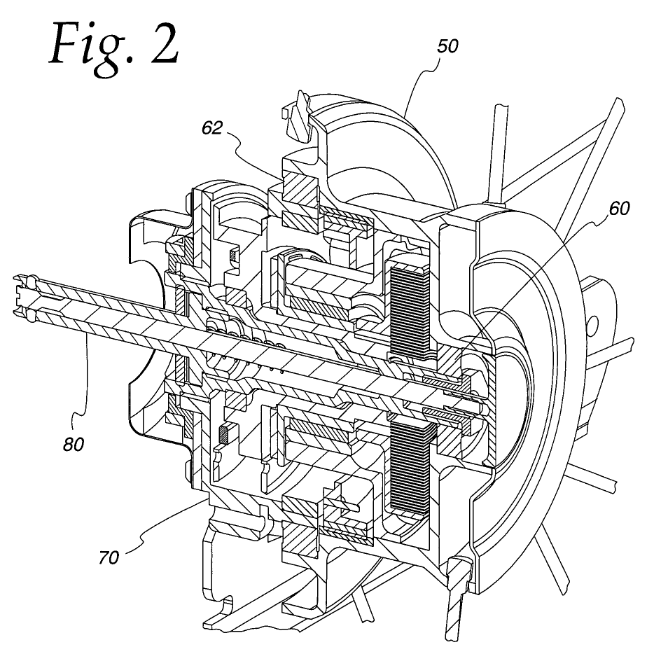

As shown in FIG. 2, driven wheels 40 comprise conventional spokes, rims, tires, and a special hub 50. Special hub 50 is supported on bearings 60 and 62. Bearing 60 is supported on quick release axle assembly 80. Bearing 62 is supported on brake shoe support assembly 70.

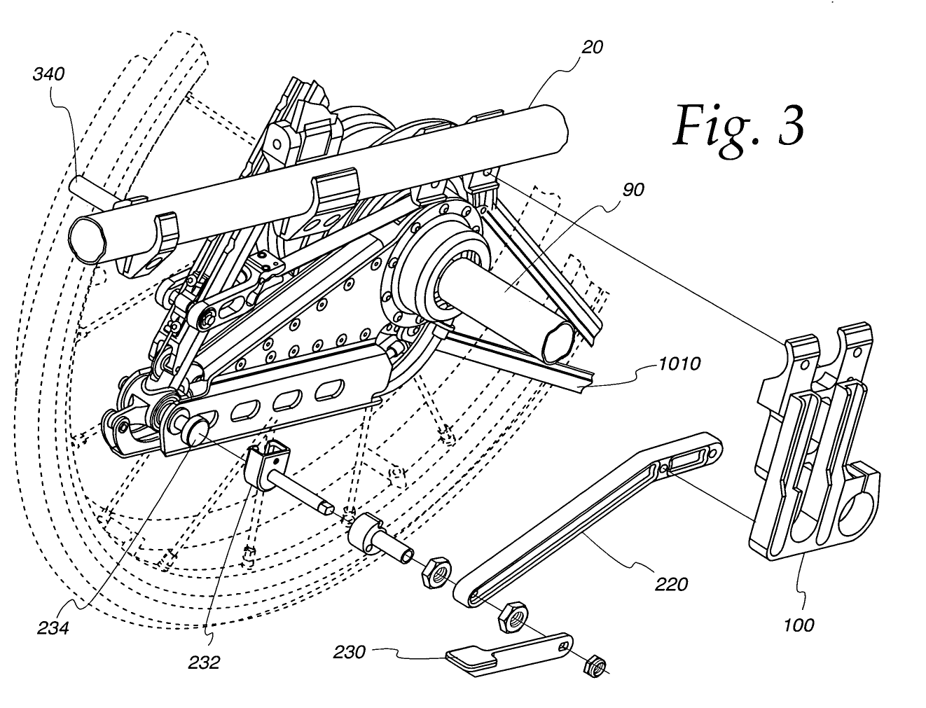

Referring to FIG. 3, quick release axle assembly 80 is supported by axle tube assembly 90. Axle tube assembly 90 is in turn fixed to wheelchair frame 20 by means of axle tube bracket assembly 100.

### Structural Elements of Drive System

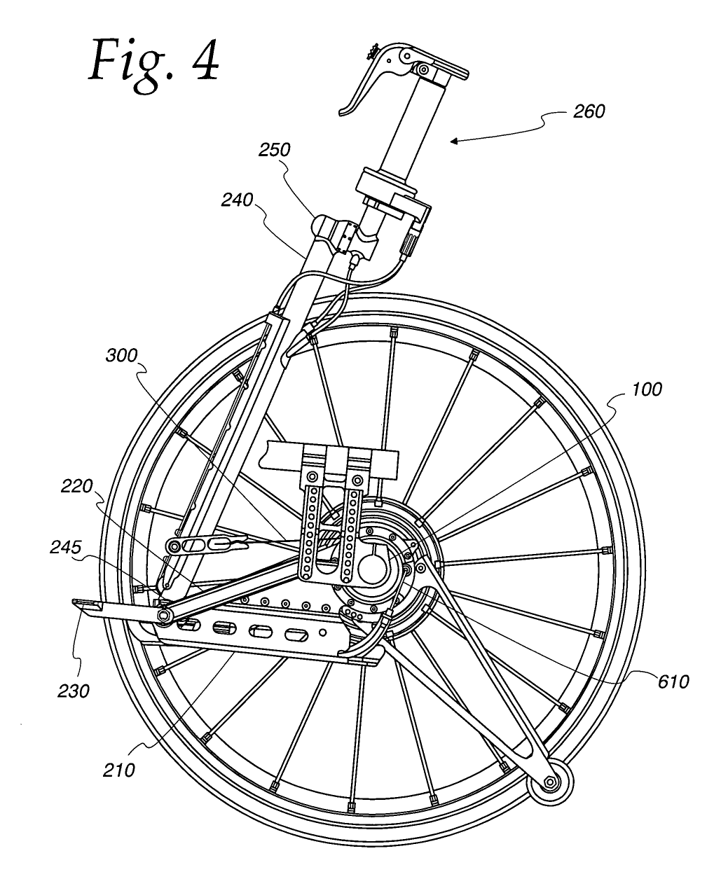

As illustrated in FIGS. 2 and 4, brake shoe support assembly 70 provides support for the drive lever pivot support bracket 210. As these assemblies are permitted to pivot on the pivotal joint between the quick release axle assembly 80 shown in FIG. 2 and axle tube assembly 90 shown in FIG. 3, it is necessary to provide a rotational fix for the drive assembly. This is provided by a drive system antirotation strut 220, depicted in FIG. 4, which is bolted to the axle tube bracket system 100.

A drive system antirotation latch 230 traps the drive lever pivot support bracket 210 to fix it rotationally relative to wheelchair frame 20.

Drive lever 240 is pivotally mounted to drive lever pivot support bracket 210 at drive lever pivot 245. Drive lever handle 260 is adjustably mounted to drive lever 240 by means of an adjustable drive lever knuckle 250.

### Functional Elements of Drive System

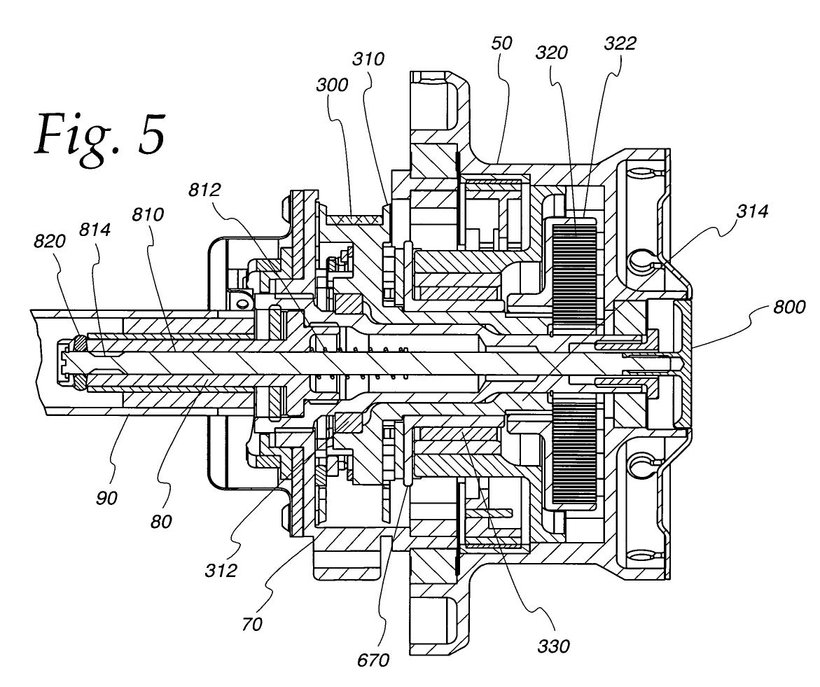

Referring now to FIG. 5, a tension element 300 wraps around drive spool 310. Drive spool 310 is supported on quick release axle assembly 80 by means of drive spool bearing 312. A torque tube extension portion 314 of drive spool 310 connects via splines (not shown) to spool rewind spring housing 322. Spool rewind spring 320 is fixed between spool rewind spring housing 322 and quick release axle assembly 80 and is preloaded in the direction to wind tension element 300 onto drive spool 310.

When the system is in the engaged state, torque occurring when tension element 300 is forcibly unwound from drive spool 310 is transmitted to the hub 50 by means of sprag clutch 330. Sprag clutch 330 is a one way clutch which permits rotation of drive spool 310 in the reverse direction relative to the hub 50.

Forward movement of drive lever 240 is preferably limited by a forward stop 340 mounted on wheelchair frame 20.

### Functional Elements of Energy Conservation Mechanism

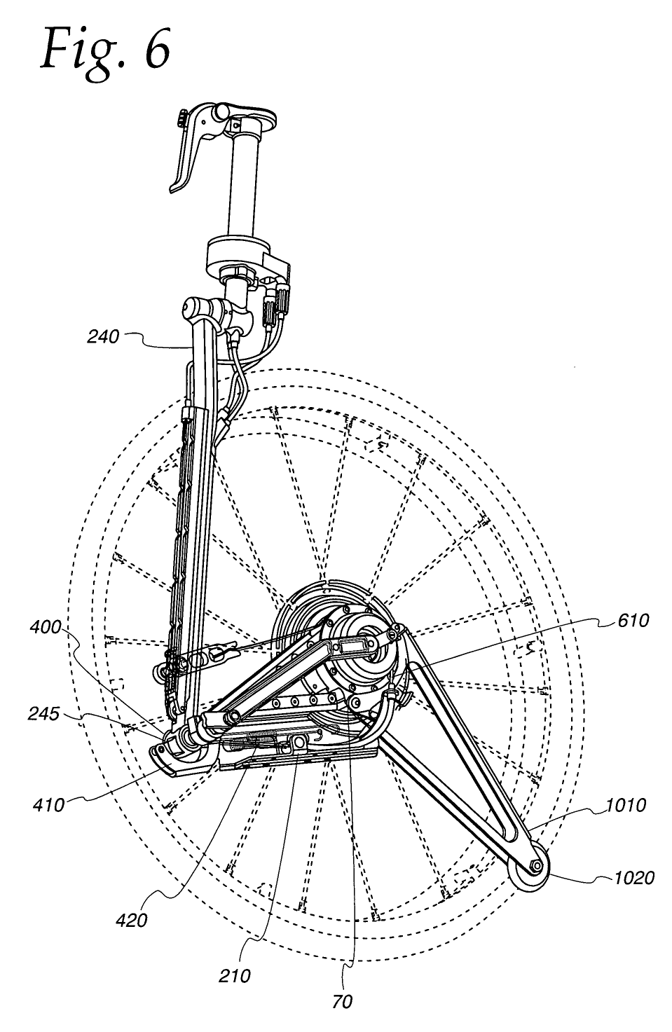

The drive system is also provided with an energy conservation mechanism to recycle the effort to work against drive spool rewind spring 320. As shown in FIG. 6, the lower end of drive lever 240 is provided with a bellcrank 400 and associated spring bracket 410. Spring bracket 410 is in turn connected to power-stroke assisting springs 420 which are preloaded and fixed to the inside of the drive lever pivot support bracket 210.

### Functional Elements of Drive Ratio Shifting Mechanism

A drive ratio shifting mechanism is provided with a twistgrip 500 that pulls and releases drive-ratio shift cables 510. As one drive-ratio shift cable 510 is pulled the other is released in equal amount. One of them is looped around a pulley 520 situated near the lower end of drive lever 240. The drive-ratio shift cables 510 terminate and are clamped to a shift traveler 530. A shift traveler pin 540 rotationally attaches to tension element shackle 550 which is fixed to tension element 300. The shift traveler pin 540 is mounted in bearings 542 which permit a rolling interaction with a notched plate 560 as shift traveler pin 540 is displaced up and down notched plate 560. A plurality of notches 562 retains the shift traveler pin 540 among various positions up and down notched plate 560. Constant tension in tension element 300 keeps the shift traveler pin 540 in a particular notch 562 until forced to move due to displacement of drive-ratio shift cable 510.

### Functional Elements of Neutral Shifting Mechanism

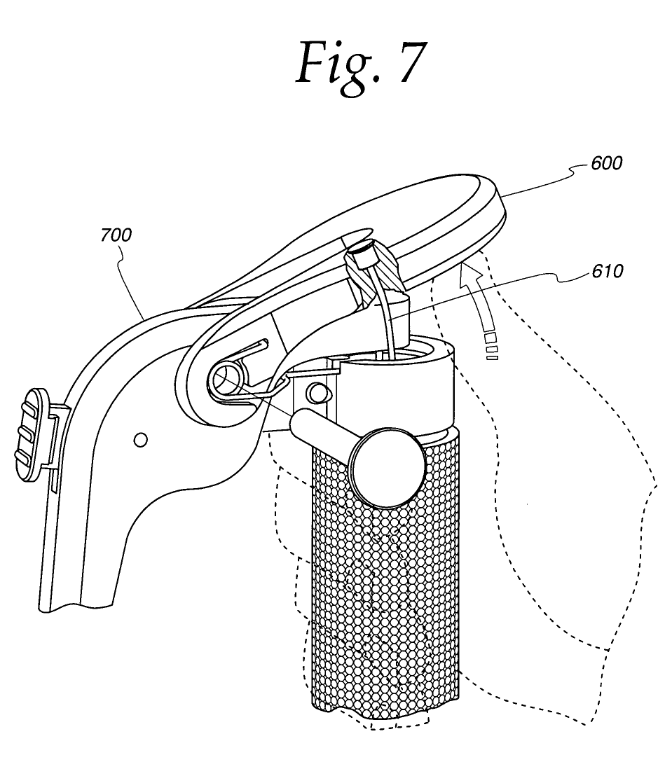

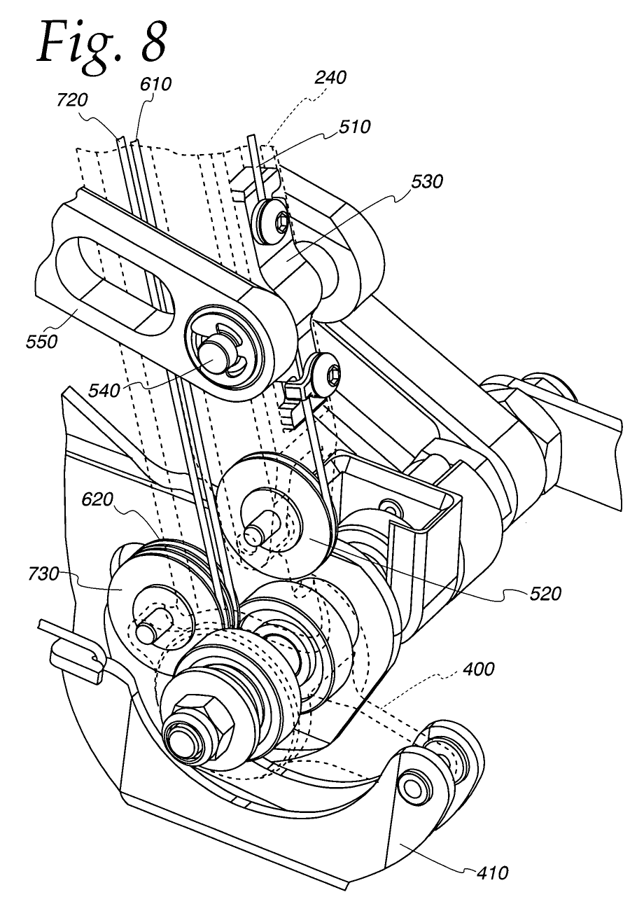

Shifting the system between an engaged and neutral state is preferably accomplished from the drive lever handle 260. In the preferred embodiment illustrated in FIG. 7, thumb lever 600 is first displaced upward, pulling one end of neutral shift cable 610, and then released. Neutral shift cable 610 is preferably routed along drive lever 240. As shown in FIG. 8, neutral shift cable 610 is internally routed along drive lever 240, but it may also be routed externally under a jacket snapped to drive lever 240, or by any equivalent arrangement. Neutral shift cable 610 changes direction near drive lever pivot 245 by means of a neutral shift pulley 620, also shown in FIG. 8. The pulley routes neutral shift cable 610 as close to the axis of rotation of pivot 245 as possible to minimize displacement of neutral shift cable 610 due to drive lever movement.

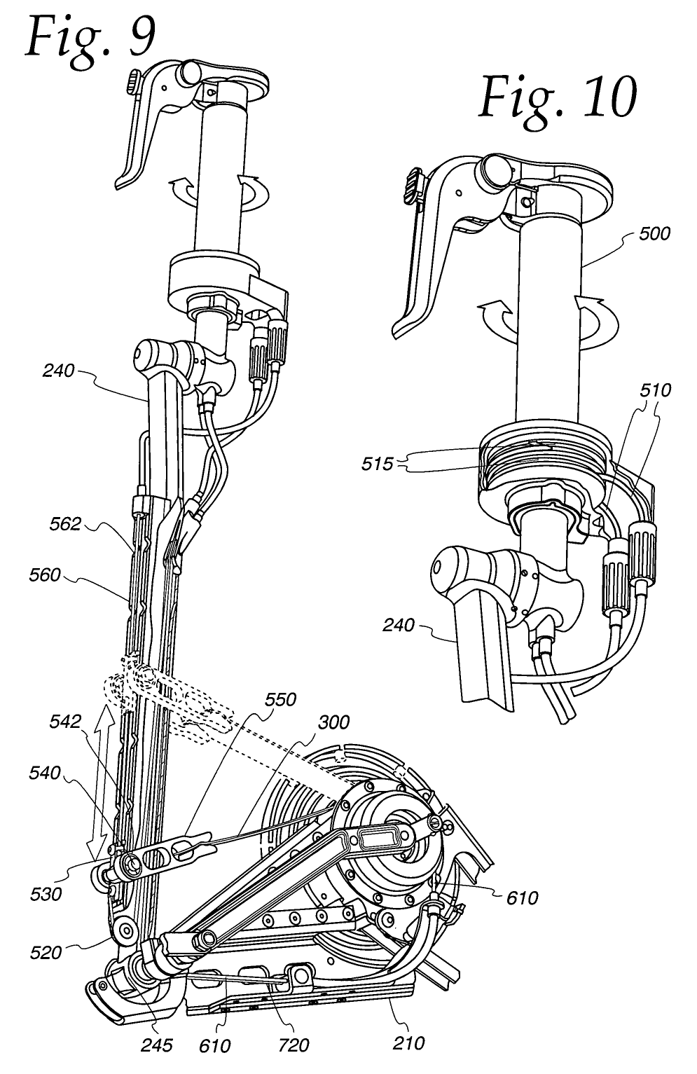

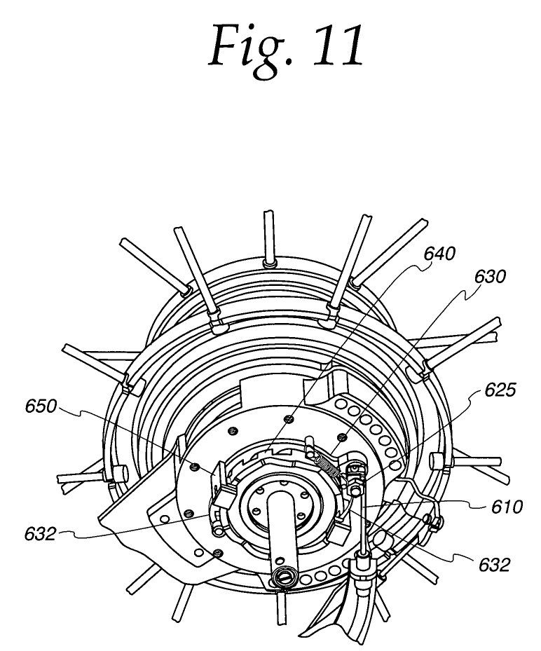

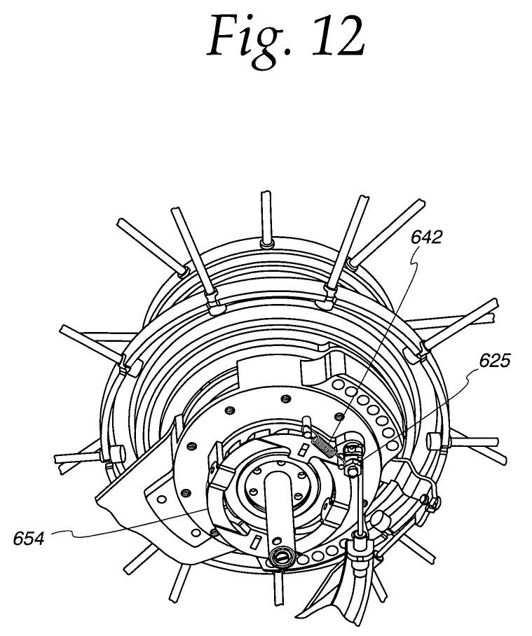

With reference to FIG. 9, neutral shift cable 610 is routed through the drive lever pivot support bracket 210 using various stops and housings in a conventional manner. At its end remote from neutral shift thumb lever 600, neutral shift cable 610 is fixed to neutral shift pawl plate pin 625, which is integral with neutral shift pawl plate 630 as shown in FIG. 11. Turning to FIG. 12, neutral shift pawl plate 630 is biased against cable tension by neutral shift pawl plate rewind spring 642. Pawl plate return spring 642 is preferably an extension spring also attached to pawl plate pin 625.

When the neutral shift thumb lever 600 is released, it permits the neutral shift cable 610 to pay out toward the hub. In turn, the neutral shift pawl plate return spring 642 causes associated pawls 632, shown in FIG. 11, to pull or rotate a neutral shift cam ring 640. When the neutral shift cable 610 is again pulled by lifting the neutral shift thumb lever 600, the pawls 632 will reach for the next purchase point on the cam ring 640.

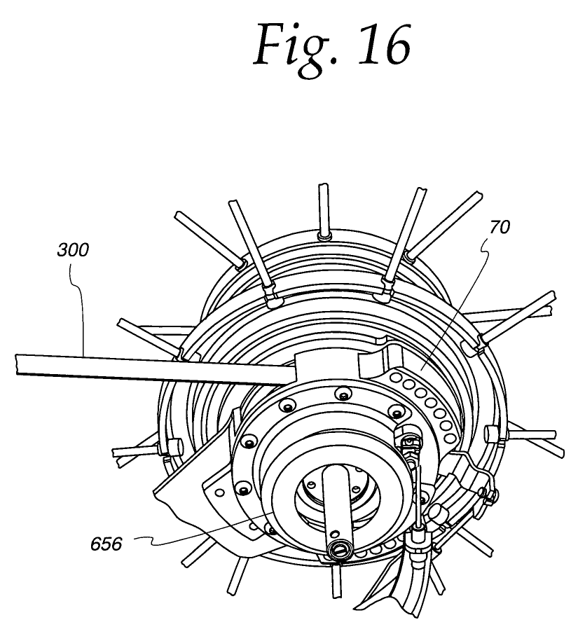

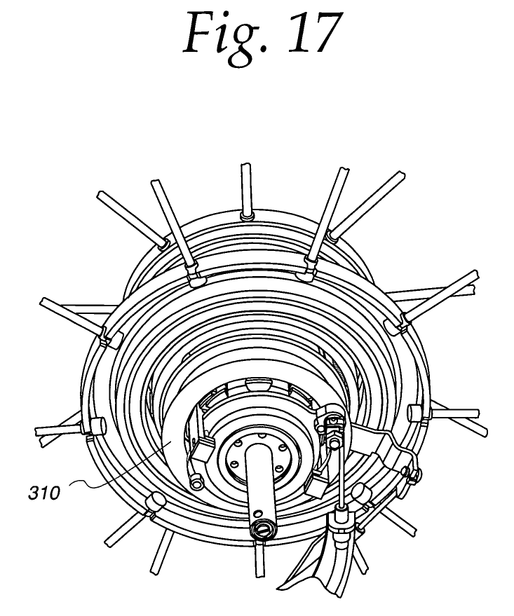

Each increment of rotation of the neutral shift cam ring 640, shown in FIG. 11, causes displacement of a cam follower integral with a neutral shift fork 650. Neutral shift fork 650 is biased in the outboard or engaged direction by a neutral shift fork preload spring 654, shown in FIG. 12. Neutral shift fork preload spring 654 is supported by the outboard face of neutral shift fork preload spring seat 656, shown in FIG. 16. Spring seat 656 is also a cover for this neutral shifting slave mechanism.

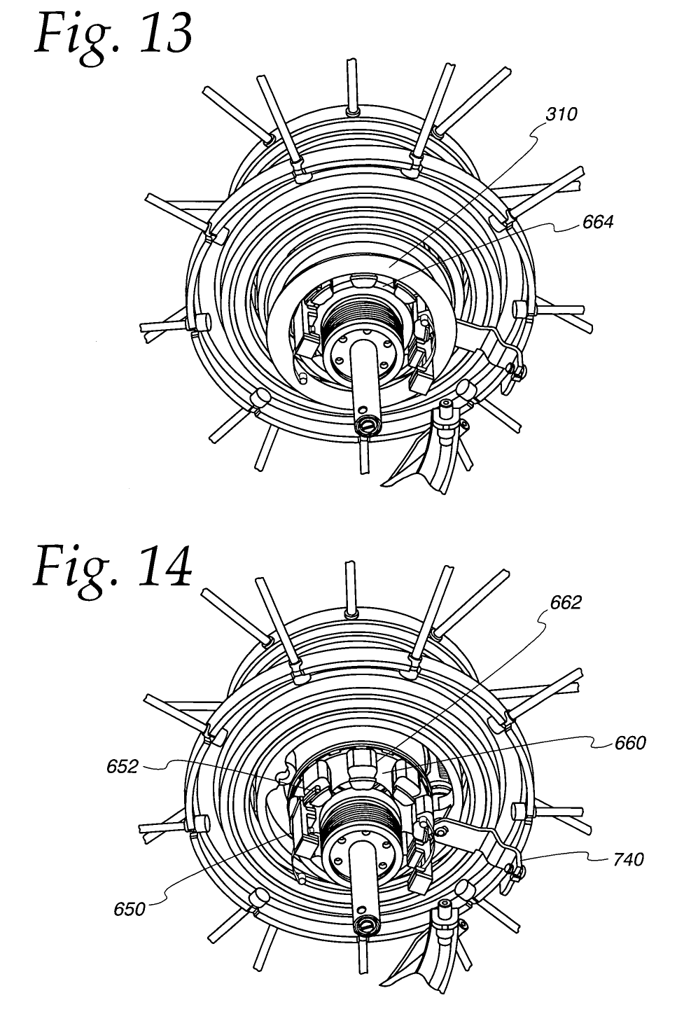

The neutral shift cam ring 640 cooperates with a cam follower integral with the neutral shift fork 650. The cam follower is diametrically situated against the cam ring 640. Each clocking of the cam ring 640 causes the neutral shift fork 650 to either compress or release the neutral shift fork preload spring 654. As shown in FIG. 14, neutral shift fork 650 is formed with an integral slipper ring portion 652. Slipper ring 652 slides in a circumferential groove formed in a male dog ring 660. Male dog ring 660 is a disk with male dog features on both inboard and outboard faces. On its inboard face, the male dog features 662, shown in FIG. 14, slidably fit into corresponding female features 664, shown in FIG. 13, integral with drive spool 310. In this way, the male dog ring 660 is always engaged to and always rotates with drive spool 310. Slipper ring 652 and integral shift fork 650 do not rotate with male dog ring 660.

The male dog ring 660 is permitted to slide axially relative to drive spool 310 as acted on by the neutral fork slipper ring 652. The slipper ring 652 and integral shift fork 650 are in turn acted on by the cam ring 640 and shift fork biasing spring 654. Shift fork biasing spring 654 preloads shift fork 650 against cam ring 640.

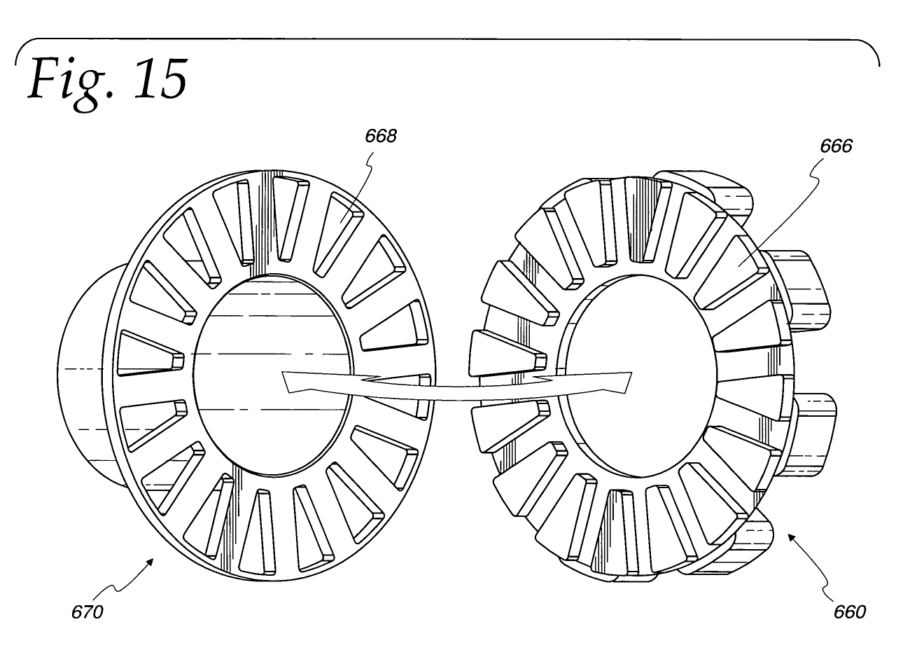

Referring to FIG. 15, the outboard face of the male dog ring 660 is also provided with male features 666 which slide into corresponding female features 668 integral with neutral shift female dog ring 670. When male dog ring 660 is displaced in the outboard direction so as to engage the corresponding features in female dog ring 670, the drive system is in an engaged state. When male dog ring 660 is pulled in the inboard direction so as to disengage the corresponding features, the drive system is in a neutral state.

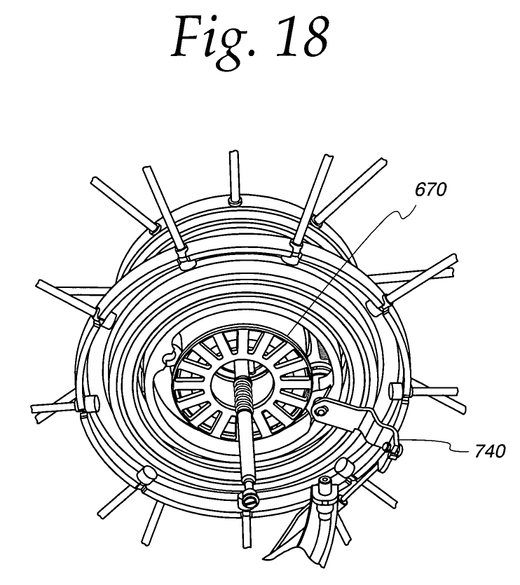

Female dog ring 670 is preferably a sintered hardened steel part. It extends in the outboard direction, i.e., into the page in FIG. 18, as a tube with a precision ground outside diameter. Turning back to FIG. 5, this cooperates with the Sprag clutch 330 which rides on the outside diameter of female dog ring 670. The outside diameter of the Sprag clutch 330 is pressed into and fixedly attached to the hub assembly 50. Thus, when male dog ring 660 is displaced outboard by the slipper ring feature 652 integral with neutral shift fork 650 which is biased outboard by the neutral shift fork preload spring 654 the system is engaged to transmit torque originating at drive spool 310 through to the hub assembly 50.

Conversely, referring to FIGS. 14, 15 and 18, when male dog ring 660 is displaced inboard by the slipper ring feature 652 integral with neutral shift fork 650, which is cammed inboard by rotation of cam ring 640, the system is in a disengaged or neutral state.

### Functional Elements of Braking System

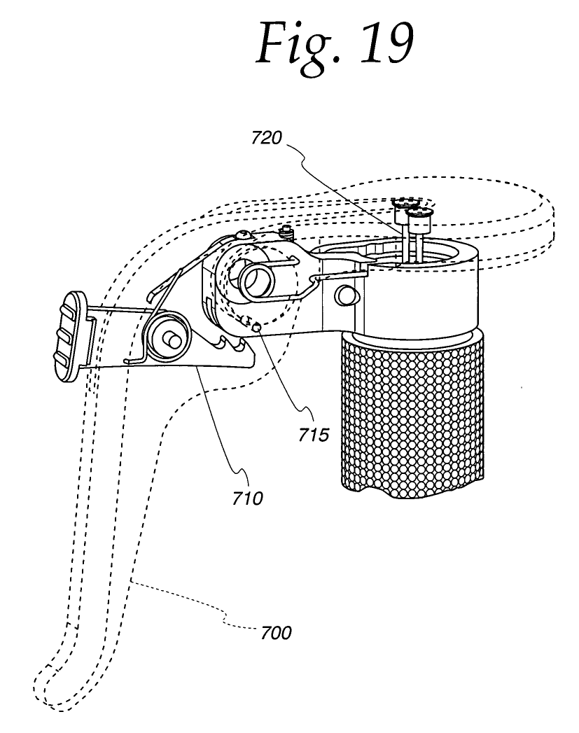

With reference to FIG. 19, braking is initiated by the occupant squeezing a brake lever 700. A releasable catchment 710 and catchment pin 715 additionally enable a parking brake function. Brake lever 700 is squeezed to pull brake cable 720. As shown in FIGS. 8 and 19, brake cable 720 is internally routed along drive lever handle 260 and drive lever 240, bypassing knuckle 250, but it may optionally be externally routed along drive lever 240 under a jacket snapped to drive lever 240 or by any equivalent arrangement. Referring to FIG. 8, brake cable 720 changes direction near drive lever pivot 245 by means of brake pulley 730. Brake pulley 730 routes brake cable 720 as close as possible to drive lever pivot 245 to minimize displacement of brake cable 720 caused by movement of drive lever 240.

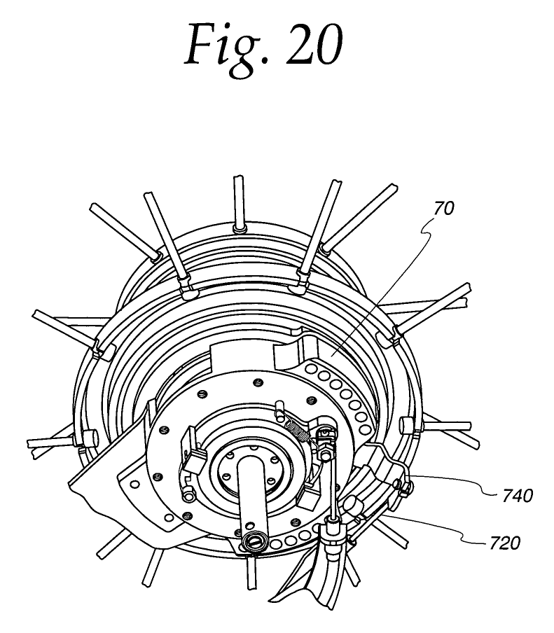

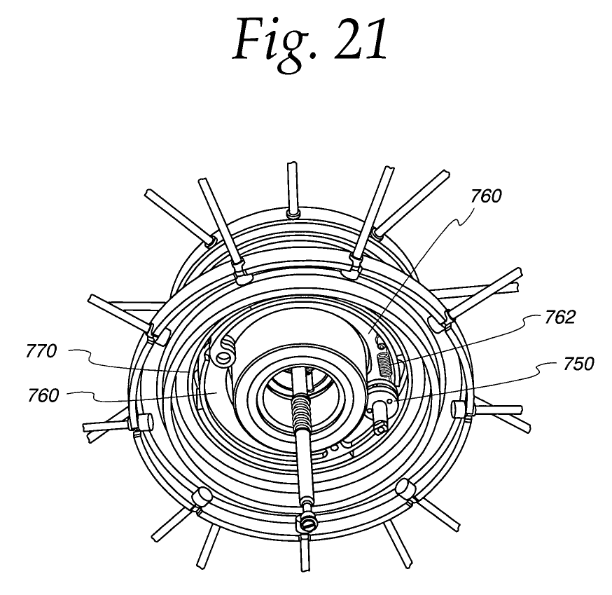

Referring to FIG. 9, brake cable 720 is routed through the drive lever pivot support bracket 210 using stops and cable housing to direct the brake cable 720 toward the brake actuator arm 740, shown in FIG. 20. The brake actuator arm 740 is affixed to a brake actuator cam 750, shown in FIG. 21. Turning to FIG. 21, the brake actuator cam 750 is biased against tension in brake cable 720 by means of brake actuator cam return spring 762. Rotation of the brake actuator cam 750 outwardly displaces brake shoes 760 toward brake drum 770. When tension in the brake cable is relaxed, brake actuator cam return spring 762 returns the cam to the non engaged state and also pulls the brake shoes 760 away from the brake drum 770. While the preferred embodiment of the invention incorporates a drum brake system, other brake systems may also be employed within the scope and spirit of the invention, including but not limited to those employing calipers or bands as stators instead of brake shoes 760, or those employing disks or wheel rims as rotors instead of brake drum 770.

### Functional Elements of Quick Release System

FIG. 6 illustrates the drive system substantially as it would look after being separated from the rest of wheelchair 10. The separation is important for handling and stowing the drive system separate from wheelchair 10. This process is facilitated by a quick release system.

The quick release system is best illustrated in FIG. 5. A quick release axle assembly 80 includes a release button 800 which, when pushed to the left in FIG. 5, also displaces release skewer 810 to the left. This action compresses quick release skewer return spring 812 and moves quick release skewer cam pockets 814 under quick release balls 820. When the quick release balls are permitted to drop into the quick release skewer cam pockets 814, the quick release axle assembly 80 can be withdrawn from the axle tube assembly 90.

Conversely, the quick release button 800 is again pushed to the left to release quick release balls 820 to permit reinsertion of quick release axle assembly 80 into axle tube assembly 90 for reassembling the drive system to wheelchair 10. Finally of course, quick release button 800 is released which cams quick release balls 820 such that quick release axle assembly 80 is again secured to axle tube assembly 90. Advantageously with regard to safety and convenience, the drive, neutral and braking systems remain functional and adjusted at all times. In particular, this avoids the potentially dangerous scenario of a user attaching a wheel and, for example, forgetting to swing brake calipers into place.

### Functional Elements of Antirotation System

The quick release system described above serves to secure the drive system to wheelchair 10. This system alone still permits the drive system to rotate about the axle tube axis. For operation it is also necessary to prevent rotation of the drive system relative to wheelchair 10. The invention provides an antirotation system as described below. The drive system is first rotatably fixed to wheelchair 10 as described above and then the antirotation system is engaged as described below.

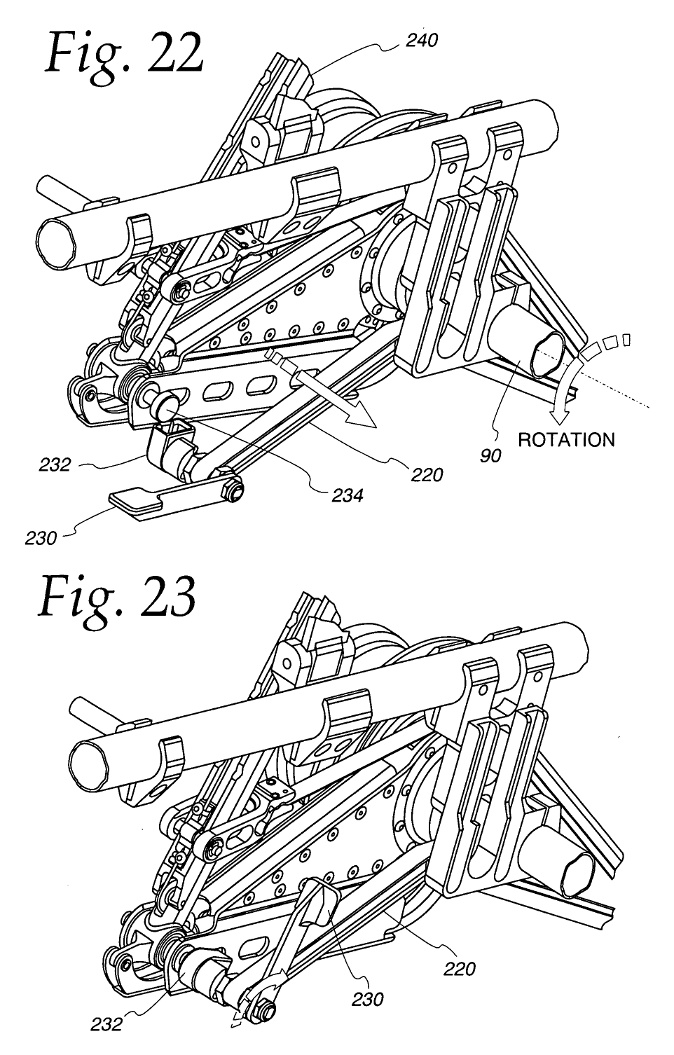

FIGS. 22 and 23 show the drive system being rotationally secured to wheelchair 10 using the antirotation system.

The drive system is provided with a boss 234 protruding inboard from drive lever pivot 245. A receiver cup 232 is oriented by antirotation latch lever 230 so as to receive boss 234. The drive system rotates en masse about the axle tube assembly 90 to fully engage the boss 234 into the receiver cup 232. When fully nested, the receiver cup 232 is rotated by means of the antirotation latch lever 230 approximately 90 degrees so that the receiver cup 232 has trapped the boss 234. An exploded view of the same parts is shown in FIG. 3.

An antirotation strut 220 maintains the position of the antirotation latch 230 relative to wheelchair frame 20.

### Functional Elements of Knuckle Adjustment System

The invention provides an adjustable drive lever knuckle 250, shown in FIG. 4, e.g., for the purpose of adjusting the angle of drive lever handle 260 relative to drive lever 240. It is desirable to make adjustments to the hand position on the fly with no tools or loose parts. Therefore the knuckle 250 is provided with a spring loaded detent system so that angular adjustments to hand position can be made by the occupant on the fly. The angular adjustments are perpendicular to the driving forces, and therefore driving forces do not cause unintentional changes in hand position. Another advantage of angular adjustments perpendicular to the driving forces is that the occupant's hand position translates inward and outward as well as rotating relative to the drive lever, thus allowing the user to choose a hand position to emphasize a particular muscle group.

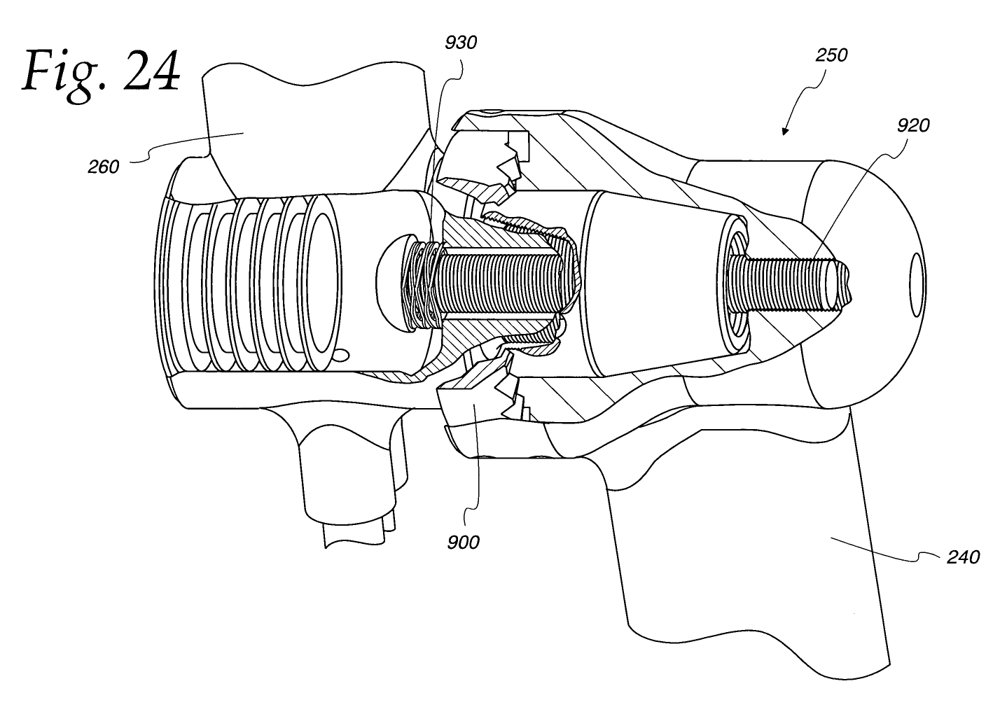

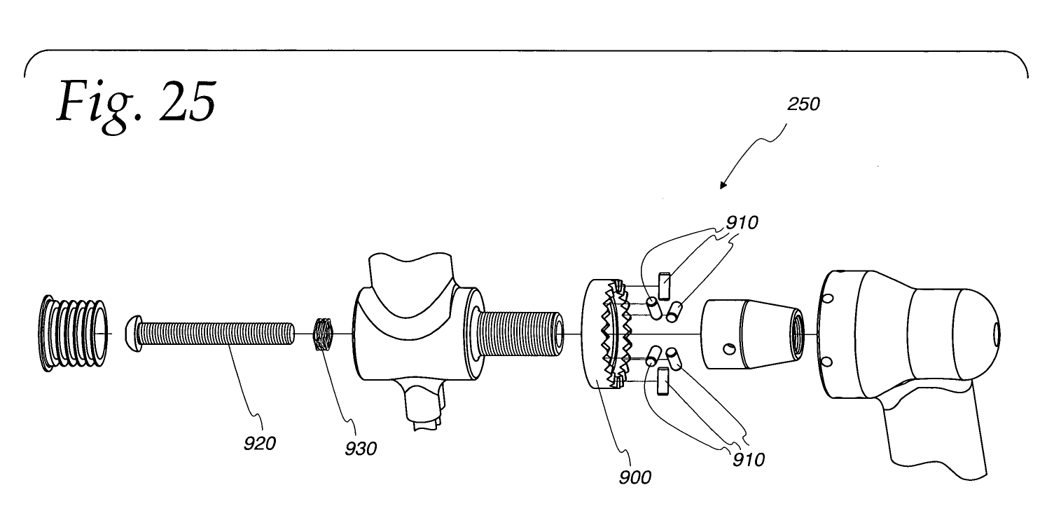

As illustrated in FIGS. 24 and 25, drive lever handle 260 is provided with a serrated disk 900, which resembles a poker chip with exaggerated angular teeth. A plurality of knuckle pins 910 associated with drive lever 240 engage the spaces between the teeth of serrated disk 900. Drive lever 240 and drive lever handle 260 are attached at knuckle 250 by knuckle through bolt 920, and the teeth of serrated disk 900 are biased toward pins 910 by a wave spring 930. The preload in wave spring 930 and contact angles between the teeth of disk 900 and pins 910 are designed to release in the desired direction when acted on by moderate hand pressure in the inboard or outboard directions. Thus, the rotational orientation of drive lever handle 260 can be adjusted on the fly by the occupant of wheelchair 10.

### Functional Elements of Antitipping System

The invention provides an antitipping system to enhance the safety of the wheelchair occupant. The system is best illustrated in FIG. 6. Anti-tipping strut 1010 is attached to brake drum support assembly 70. The anti-tipping system is provided with wheels 1020 for quiet and efficient contact with the ground when preventing tipping. There are preferably two antitipping struts 1010, one associated with each drive system, right and left.

### Driving Operation

During normal driving operation of the wheelchair according to the illustrated embodiment, the user pushes forward on drive levers 240 to propel wheelchair 10 forward. Each drive lever 240 pivots on a drive lever pivot 245. Tension element 300 is drawn forward as it is attached at its forward end to drive lever 240. The rearward end of tension element 300 is pulled off drive spool 310 and therefore causes drive spool 310 to rotate in the forward direction. Drive spool 310 is connected by means of a one way clutch to special hub 50. The forward movement of the drive lever constitutes the power stroke and is ended at an arbitrary point according to the user's preference.

At the end of the power stroke, the user pulls back on drive levers 240, bringing them to an arbitrary starting point to begin the next power stroke. During this recovery stroke drive spool rewind spring 320 winds the drive cable back onto drive spool 310. The ratchet connection between drive spool 310 and special hub 50 permits free rotation of drive spool 310 in the rearward direction without kinematic restraint from the special hub 50. That is to say, while backward rotation of the driven wheel may impel the drive spool to rewind, no rotation of the driven wheel may keep the drive spool from rewinding.

It is desirable to minimize the backlash or take-up that could occur if drive lever 240 does not immediately engage the special hub 50 at the commencement of the forward movement of the power stroke. For this reason a relatively zero backlash ratchet such as a Sprag clutch, roller clutch or Mechanical Diode is preferable to a standard ratchet and pawl system. Another consideration to minimize backlash is to use a rewind spring that is sufficiently robust and a tension element 300 that is sufficiently flexible in bending so that it stays snugly wound on drive spool 310 and then takes a relatively straight path from its departure or tangent point on drive spool 310 on its way forward to the drive lever.

### Note on Driving Operation

Although the wheelchair 10 illustrated in the attached Figures and described in the present detailed description is driven forward by pushing the drive levers 240 in the forward direction, thereby causing the drive spools 310 to rotate forward, it should be noted that, by simple modifications to the illustrated embodiment, the direction of the power stroke applied to the drive levers 240 and/or of the rotation of the drive spool 310 that transmits forward rotation to the driven wheels 40 could be reversed. By way of example and not limitation, tension element 300 could connect to the front of drive lever 240 and reverse direction by way of a pulley mounted in front of drive-lever pivot 245, thereby transmitting forward rotation to drive spool 310 when drive lever 240 is pulled backward. Alternatively, tension element 300 could thread underneath drive spool 310 so that backward rotation is transmitted to drive spool 310 when drive lever 240 is pushed forward, and the backward rotation of drive spool 310 could transmit forward rotation to driven wheel 40 by way of a conventional gear train. In another alternative, rotation could be transmitted from drive lever 240 to a drive rotor by other means than a flexible tension element, such as by a rack and pinion assembly or a conventional gear train, while still advantageously employing the power-stroke assisting spring 420 of the present invention to store energy used by the pulling muscles and use that energy to assist the pushing muscles in the power stroke, or vice-versa. Modifications to driving operation including but not limited to the foregoing examples are within the scope and spirit of the present invention.

### Drive Ratio Shifting Operation

The drive ratio is a function of various dimensions. It is substantially proportional to the distance from drive lever pivot 245 to the attachment point of tension element 300 to drive lever 240 and to the radius of driven wheel 40. It is substantially inversely proportional to the distance from drive lever pivot 245 to drive lever handle 260 and to the radius of drive spool 310.

Referring to FIG. 9, the ratio of wheel rotation to lever movement or “drive ratio” is adjustable by moving tension element shackle 550 up and down drive lever 240 in the directions indicated by the straight arrow shown. Shifting can only be effected during a rearward recovery stroke, or when drive lever 240 is at rest, when traveler pin 540 is not loaded by driving forces in tension element 300. During a recovery stroke the operator may shift drive ratios by rotating twistgrip 500 in the rotational directions indicated by the circular arrow shown in FIGS. 9 and 10.

During a forward power stroke, there is significant tension in tension element 300. Traveler pin 540 is maintained in the selected notch 562 because the contact angles between the pin 540 and notch 562 are sufficient to keep the pin in place even when tension element 300 is not perpendicular to the drive lever, resulting in a component of tension tangential to drive lever 240.

The traveler pin 540 is raised or lowered by drive-ratio shift cables 510. As shown in FIG. 10, drive-ratio shift cables 510 are wound and unwound from drive ratio shift spools 515 integral with the hand controls of twistgrip 500. One drive-ratio shift cable 510 is routed through a drive-ratio shift pulley 520 near drive lever pivot 245 so that it pulls traveler pin 540 down toward pivot 245 for downshifting, while the other drive-ratio shift cable 510 is routed directly to shift traveler 530 so that it pulls traveler pin 540 up drive lever 240 for upshifting.

The contact angle between the traveler pin 540 and the notches 562 combined with tension element 300 tension due to drive spool rewind spring 320 is such that there will be a detented or indexed feel in twistgrip 500. The two drive-ratio shift cables 510 need only be adjusted to be taut. Since notches 562 are in the slave mechanism, the shifting system is essentially self adjusting with respect to indexed shifting.

While the illustrated embodiment incorporates a traveler pin 540 and notches 562, it should be noted that any suitable equivalent combination of an engaging and receiving feature that retains shift traveler 530 in a fixed position on drive lever 240 during driving operation could be substituted for the pin 540 and notches 562 within the scope and spirit of the invention.

### Tension Element 300

Tension element 300 illustrated in the preferred embodiment is preferably a Kevlar reinforced elastomeric matrix belt. Tension element 300 can also be made of a large variety of materials and structures that have strength in tension yet have flexibility in bending so that they can wind around drive spool 310. For example, without limitation, tension element 300 can be made out of a Kevlar rope, or any braided or stranded structure that has the required strength in tension and drape in bending such as a bicycle brake cable. Tension element 300 can also be made of a composite structure such as steel wire reinforced elastomer. It is also possible to eliminate the need for a discrete cable recoil spring by employing as tension element 300, for example, a tensator type spring which is prestressed to wind itself into a coil in one mode and extend itself straight in its second mode, thus serving as both tension element 300 and spool rewind spring 420.

### Neutral Operation

Any practical wheelchair must be able to back up or “turn on a dime.” All devices using a drive spool with a one way clutch and rewind spring must have the capability to decouple the transmission from each driven wheel. With respect to the present invention, each driven special hub 50 incorporates a coupler-decoupler mechanism which permits the operator to achieve a neutral gear for manual maneuvering of wheelchair 10. The invention provides for convenient neutral shifting from the hand control position on the drive lever handle.

The neutral state can be achieved any time other than during a power stroke and regardless of lever position. When in the neutral state, drive levers 240 can be moved to any position without driving wheelchair 10 forward. Wheelchair 10 can be driven backwards or “turned on a dime” using the conventional hand rims when in the neutral state.

### Braking Operation

In the preferred embodiment the brake system is a drum brake. The brakes are preferably independent right and left to assist with steering. They are conveniently controlled from drive lever handle 260. They may be used at any time regardless of drive lever force or position.

In the case that the user prefers both right and left brakes to be actuated from a single brake actuation lever, a brake cable splitter and balancer can be employed. This would be similar to standard components available in bicycle shops and motorcycle shops.

### Variable Hand Position Operation

Due to the use of Bowden type control cables to bridge across adjustable drive lever knuckle 250, the angle between the hand controls and the drive lever can be adjusted to suit the user's preference, allowing the user to rotate and translate the user's hand position relative to the drive lever.

### Driving Operation Using Power-Stroke Assisting Springs

In normal driving operation, power-stroke assisting springs 420 associated with drive lever pivots 245 are preloaded to bias the drive levers 240 in the forward direction so as to substantially compensate for the average rewinding or rearward preload associated with drive spool rewind spring 320. The power-stroke assisting springs allow the operator to elastically recover a substantial amount of the energy lost to overcoming the undesirable, but necessary, rewinding forces in tension element 300. In other words, if spool rewind spring 320 associated with drive spool 310 is left unopposed by a power-stroke assisting spring, then each power stroke must throw away the energy required to wind up that spring. Power-stroke assisting spring 420 substantially alleviates this energy loss by recycling it. The energy flows back and forth between the opposed springs 320 and 420. The system is operable and useful without a power-stroke assisting spring as in prior art devices, but an energy loss equal to the component of belt tension due to rewind spring 320 times the path length of tension element 300 during the power stroke will inevitably occur each power stroke.

This is a subtle but important concept. The basic principle is that a spring is a substantially elastic element. By definition this means that it can perform a cycle of positive and negative work in equal amounts with no net change of energy state. In contrast, muscles are largely inelastic, meaning that they expend metabolic energy whether they are performing positive or negative work. The power-stroke assisting spring discussed above provides a parallel path for negative work to be routed through the springs where it can be recycled to do positive work rather than be routed through the muscles where it will simply consume additional metabolic energy.

In another optional mode of operation, power-stroke assisting spring 420 is adjustably preloaded in excess of the amount required to cancel, on average, rewind spring 320. In this mode, the user stores even more potential energy in power-stroke assisting spring 420 during the recovery or rearward phase of the power stroke cycle. This potential energy is then released during the forward power stroke. In other words, the pulling muscles do work that subtracts from the work performed by the pushing muscles for the same average muscular power output.

Adjustability of power-stroke assisting spring 420 may be achieved in a number of ways. By way of example and not limitation, one power-stroke assisting spring 420 may be removed and replaced with a stiffer or softer spring. Alternatively, one end of power-stroke assisting spring 420 may be threaded onto a mandrel, the mandrel rotatably mounted relative to the drive lever pivot support bracket 210, so that the mandrel may be rotated to increase or decrease tension in power-stroke assisting spring 420. In another possible arrangement, the power-stroke assisting spring 420 may be attached to a plate, the plate threaded onto an adjustment screw rotatably mounted relative to the drive lever pivot support bracket 210, so that the screw may be rotated to increase or decrease tension in power-stroke assisting spring 420.

### Quick Release Operation

Focus group studies show that wheelchair users prefer to disassemble the wheels from the wheelchair frame for the purpose of stowing the disassembled wheelchair for stowage and transport in another vehicle.

In the case of a lever driven wheelchair as is the case in the present invention, it was found that any extra weight associated with the driving and braking mechanism should preferably separate from the wheelchair frame and remain with the wheels upon disassembly. This avoids adding weight to the wheelchair frame, which is already significantly heavier than the wheels. The present invention integrates all of the driving and braking mechanisms to the driven wheels 40. When the drive system is separated using the quick release system, the wheelchair frame 20 that remains is basically a'standard off-the-shelf frame with only two very light antirotation struts 220 added.

Although the present invention is described with respect to wheelchairs, it is understood that the present invention is not limited to such. The present invention can be used on all types of vehicles, and craft. Particularly on human powered vehicles and craft wherein the input is a reciprocating input and the output is a rotating output such as a wheel or propeller.

It will be appreciated by persons skilled in the art that the present invention is not limited to what has been particularly shown and described herein above. In addition, unless mention was made above to the contrary, it should be noted that not all of the accompanying drawings are to scale. A variety of modifications and variations are possible in light of the above teachings without departing from the scope and spirit of the invention, which is limited only by the following claims:

What is claimed is:

1. A human powered vehicle drive system comprising
at least one drive lever, the drive lever pivotally mounted relative to a vehicle frame and pivotable about a drive-lever pivot in a power stroke direction and a recovery stroke direction opposite the power stroke direction;
a drive rotor rotatably mounted with respect to the vehicle frame, the drive rotor operatively connected to the drive lever and constrained to rotate in a driving direction with respect to the vehicle frame when a power stroke is applied to the drive lever; and
a power-stroke assisting spring providing a power-stroke assisting torque to the drive lever about the drive lever pivot in the power-stroke direction.

2. The drive system of claim 1, wherein the vehicle frame is a wheelchair frame and the drive rotor is a drive spool, further comprising
a tension element connected to the drive lever at a distal end of the tension element and to the drive spool at its proximal end, the tension element constrained to unwind from the drive spool when a power stroke is applied to the drive lever, causing the drive spool to rotate in the driving direction with respect to the wheelchair frame;
a spool rewind spring biasing the drive spool to rotate in a rewind direction opposite the driving direction to rewind the tension element onto the drive spool, thereby maintaining tension in the tension element;
a driven wheel rotatably mounted with respect to the wheelchair frame; and
a ratchet-type transmission system constraining the driven wheel to rotate forward with respect to the wheelchair frame when the drive spool rotates in the driving direction with respect to the wheelchair frame, without kinematically restraining rotation of the drive spool in the rewind direction.

3. The drive system of claim 2, wherein the magnitude of the power-stroke assisting torque on the drive lever due to the power-stroke assisting spring is less than or equal to the magnitude of a biasing torque in the recovery-stroke direction caused by the spool rewind spring.

4. The drive system of claim 2, wherein the power-stroke assisting torque provided by the power-stroke assisting spring produces a net power-stroke assisting torque on the drive lever about the drive-lever pivot.

5. The drive system of claim 1, wherein the power-stroke assisting torque provided by the power-stroke assisting spring is adjustable according to a user's preference.

6. A human powered vehicle drive system comprising
at least one drive lever, the drive lever pivotally mounted relative to a vehicle frame and pivotable about a drive-lever pivot in a power-stroke direction and a recovery-stroke direction opposite the power-stroke direction;
a shift traveler slidingly connected to the drive lever, the shift traveler having an engaging feature adapted to engage any of a plurality of receiving features distributed along and fixed with respect to the drive lever;
a tension element connected to the shift traveler at a distal end of the tension element and to a drive spool at its proximal end, the drive spool rotatably mounted relative to the vehicle frame and the tension element constrained to unwind from the drive spool when a power stroke is applied to the drive lever;
a spool rewind spring biasing the drive spool to rotate in the rewind direction to rewind the tension element onto the drive spool, thereby providing constant tension in the tension element; and
a drive-ratio shift actuator operatively connected to a drive-ratio shift linkage, the drive-ratio shift linkage connected to the shift traveler;
wherein operating the shift actuator displaces the shift traveler along the drive lever, causing the shift traveler engaging feature to engage a selected receiving feature and thereby varying a drive ratio of an output rotation of the drive spool to an input rotation of the drive lever,
wherein constant tension in the tension element provided by the spool rewind spring prevents the shift traveler engaging feature from disengaging a receiving feature during a recovery stroke of the drive lever or when the drive lever is at rest without operation of the actuator, and
wherein the range of contact angles between the shift traveler engaging feature and the surfaces of the receiving features during a power stroke prevents the shift traveler engaging feature from disengaging any receiving feature due to the component of tension in the tension element tangential to the drive lever.

7. The drive system of claim 6, further comprising a power-stroke assisting spring providing a power-stroke assisting torque to the drive lever about the drive-lever pivot.

8. A human powered wheelchair comprising the drive system of claim 6, wherein the vehicle frame is a wheelchair frame, further comprising a driven wheel rotatably mounted relative to the wheelchair frame,
the driven wheel constrained by a one-way clutch to rotate forward with respect to the wheelchair frame when the drive spool rotates in the driving direction with respect to the wheelchair frame and
the one-way clutch permitting the drive spool to rotate in the rewind direction without kinematic restraint from the driven wheel.

9. A human powered vehicle drive system comprising
a) a power system comprising
at least one drive lever, the drive lever pivotally mounted relative to a vehicle frame and pivotable about a drive-lever pivot in a power stroke direction and a recovery stroke direction opposite the power stroke direction;
a tension element operatively connected to the drive lever at a distal end of the tension element and connected to a drive spool at its proximal end, the drive spool rotatably mounted relative to the vehicle frame and the tension element constrained to unwind from the drive spool when a power stroke is applied to the drive lever, causing the drive spool to rotate in a driving direction;
a spool rewind spring biasing the drive spool to rotate in a rewind direction opposite the driving direction and tending to rewind the tension element onto the drive spool;
a one-way clutch which, when engaged, constrains a driven, rotatable propulsion member to rotate so as to propel the vehicle frame forward when the drive spool rotates in the driving direction with respect to the vehicle frame, without kinematically restraining rotation of the drive spool in the rewind direction, and when disengaged, permits the drive spool and propulsion member to rotate freely with respect to each other; and
b) a neutral shifting system comprising
a neutral shift actuator operatively connected to a neutral shift linkage, the neutral shift linkage operatively connected to the one-way clutch;
whereby the neutral shift linkage, when actuated by the neutral shift actuator, engages and disengages the one-way clutch.

10. The drive system of claim 9, further comprising a power-stroke assisting spring providing a power-stroke assisting torque to the drive lever about the drive-lever pivot.

11. The drive system of claim 9, wherein the neutral shift actuator is proximate to a drive lever handle, the drive lever handle coupled to the drive lever.

12. The drive system of claim 11, wherein the angle of the drive lever handle with respect to the drive lever is adjustable according to a user's preference.

13. A human powered wheelchair comprising
a) a power system comprising
at least one drive lever handle coupled to at least one drive lever, the drive lever pivotally mounted relative to a wheelchair frame and pivotable about a drive-lever pivot in a power stroke direction and a recovery stroke direction opposite the power stroke direction;
a tension element operatively connected to the drive lever at a distal end of the tension element and connected to a drive spool at its proximal end, the drive spool rotatably mounted relative to the vehicle frame and the tension element constrained to unwind from the drive spool when a power stroke is applied to the drive lever, causing the drive spool to rotate in a driving direction;
a spool rewind spring biasing the drive spool to rotate in a rewind direction opposite the driving direction and tending to rewind the tension element onto the drive spool;
a one-way clutch which constrains a driven wheel to rotate so as to propel the vehicle frame forward when the drive spool rotates in the driving direction with respect to the vehicle frame, without kinematically restraining rotation of the drive spool in the rewind direction; and
b) a brake system comprising a brake actuator proximate to the drive lever handle, the brake actuator connected to a flexible brake linkage and the flexible brake linkage operatively connected to a brake;
wherein the power system and brake system are assembled to the driven wheel, and
wherein the driven wheel, power system and brake system may be quickly attached to and released from the wheelchair frame as an assembled unit.

14. The wheelchair of claim 13, further comprising a neutral shifting system comprising a neutral shift actuator operatively connected to a neutral shift linkage, the neutral shift linkage operatively connected to the one-way clutch;
whereby the neutral shift linkage, when actuated by the neutral shift actuator, engages and disengages the one-way clutch, and
wherein disengaging the one-way clutch permits the driven wheel and drive spool to rotate freely relative to each other.

15. The wheelchair of claim 13, further comprising
a shift traveler slidingly connected to the drive lever and connected to the distal end of the tension element, the shift traveler having an engaging feature adapted to engage any of a plurality of receiving features distributed along and fixed with respect to the drive lever; and
a drive-ratio shift actuator proximate to the drive lever handle and operatively connected to a drive-ratio shift linkage, the drive-ratio shift linkage connected to the shift traveler;
wherein operating the shift actuator displaces the shift traveler along the drive lever, causing the shift traveler engaging feature to engage a selected receiving feature and thereby varying a drive ratio of an output rotation of the drive spool to an input rotation of the drive lever,
wherein constant tension in the tension element provided by the spool rewind spring prevents the shift traveler engaging feature from disengaging a receiving feature during a recovery stroke of the drive lever or when the drive lever is at rest without operation of the actuator, and
wherein the range of contact angles between the shift traveler engaging feature and the surfaces of the receiving features during a power stroke prevents the shift traveler engaging feature from disengaging any receiving feature due to the component of tension in the tension element tangential to the drive lever.

16. The wheelchair of claim 13, further comprising a power-stroke assisting spring providing a power-stroke assisting torque to the drive lever about the drive-lever pivot.

17. The wheelchair of claim 13, wherein the angle of the drive lever handle with respect to the drive lever is adjustable according to a user's preference.

18. A human powered wheelchair comprising
a) a power system comprising
at least one drive lever, the drive lever pivotally mounted relative to a vehicle frame, pivotable about a drive-lever pivot in a power stroke direction and a recovery stroke direction opposite the power stroke direction, and operatively connected to a drive rotor, the drive rotor rotatably mounted relative to the wheelchair frame and constrained to rotate in a driving direction with respect to the wheelchair frame when a power stroke is applied to the drive lever; and
a driven wheel connected to the drive rotor by way of a one-way clutch, the one-way clutch constraining the driven wheel to rotate forward with respect to the wheelchair frame when the drive rotor rotates in the driving direction with respect to the wheelchair frame, without kinematically restraining rotation of the drive rotor in a return direction opposite the driving direction; and
b) a brake system comprising
a brake;
a brake actuator; and
a flexible brake linkage connected to the brake actuator at a proximal end of the flexible brake linkage, the flexible brake linkage routed along the drive lever and operatively connected to the brake at its distal end; and
wherein movement of the drive lever will not apply the brake when the brake actuator has not been triggered.

19. The wheelchair of claim 18, further comprising a power-stroke assisting spring providing a power-stroke assisting torque to the drive lever about the drive-lever pivot.

20. The wheelchair of claim 18, further comprising a drive lever handle coupled to the drive lever, wherein the brake actuator is proximate to the drive lever handle.

21. The wheelchair of claim 20, wherein the angle of the drive lever handle with respect to the drive lever is adjustable according to a user's preference.
